(19) United States
(12) Patent Application Publication
(10) Pub. No.: US 2019/0174909 A1
(43) Pub. Date: Jun. 13, 2019

(54) ELECTRIC TOOTHBRUSH HEAD AND SHAFT COUPLER CONFIGURED TO CONNECT TOOTHBRUSH HEAD AND POWER OUTPUT SHAFT

(71) Applicant: SHENZHEN INSMART TECHNOLOGY CO., Shenzhen City (CN)

(72) Inventor: JIANG HUANG, PINGXIANG CITY (CN)

(21) Appl. No.: 16/109,712

(22) Filed: Aug. 22, 2018

(30) Foreign Application Priority Data
Dec. 12, 2017 (CN) 201711323964.X

(51) Int. Cl. A46B 13/02; A46B 5/02; A46B 5/00; F16D 1/05

(52) U.S. Cl. CPC A46B 13/023; A46B 5/02; A46B 2200/1066; F16D 1/05; A46B 5/0095

(57) ABSTRACT

Disclosed are an electric toothbrush head and a shaft coupler configured to connect a toothbrush head and a power output shaft. The shaft coupler includes a connection member (1) and an elastic member (2). The connection body (1) of the connection member (14) is disposed with two openings (143, 144) extending along an axial direction, the two openings (143, 144) are configured to divide at least one section of the connection body (14) into two opposite clamping portions (141, 142) along the axial direction and the elastic member (2) is sleeved at an outer periphery of the two clamping portions (141, 142) for applying an elastic force which is capable of making the two clamping portions (141, 142) vibrate the power output shaft in the two clamping portions (141, 142). The toothbrush head includes a bar and the shaft coupler.

### BACKGROUND

### 1. Technical Field

The present disclosure relates to an electric toothbrush, in particular, to a shaft coupler capable of removably assembling the toothbrush head on the power output shaft extending from the front end of the toothbrush handle, as well as carrying out torque transmission and axial retention of the toothbrush head relative to the power output shaft.

### 2. Description of Related Art

Conventionally, electric toothbrushes have the following structure, including assembling a driving mechanism in the toothbrush handle, the power output shaft of the driving mechanism extending from the front end of the toothbrush handle, disposing a shaft coupler at the bar of the toothbrush head, removably assembling the toothbrush head on the power output shaft extending from the front end of the toothbrush handle through the shaft coupler, and driving the toothbrush head to oscillate or vibrate through the rotation of the power output shaft.

When manufacturing the abovementioned electric toothbrushes, manufacturers have to make the connection portion between the toothbrush head and the power output shaft have better adaption and coaxiality so as to consume less power in the process of power transmission and ensure reliability of the torque transmission, as well as enabling the toothbrush head to be removed from the power output shaft easily.

FIGS. 1a and 1b illustrate respectively the connection member 40 and the elastic member 50 of a shaft coupler of an existing electric toothbrush, and FIG. 1c illustrates the power output shaft 60 of an existing electric toothbrush. The shaft coupler includes connection member 40 and the elastic member 50, and the electric toothbrush includes the shaft coupler and power output shaft 60. The connection member 40 includes the base 44 and a connection body 45, the connection body 45 is provided with an opening along the axial direction to enable the connection body 45 to contract inwardly when an external force is applied to the connection body 45, two opposite walls at the internal side of the connection body 45 are disposed with two elastic protrusions 42, 43, the two elastic protrusions 42, 43 are staggered in the axial direction of the power output shaft 60, and the external wall 61 of the power output shaft 60 is disposed with the contact portion 62 which cooperates with the elastic protrusion 42. When the power output shaft 60 is inserted into the connection member 40, the elastic protrusion 42 is in physical contact with the contact portion 62 at one side surface of the power output shaft 60 and the elastic protrusion 43 is in physical contact with the other side surface of the power output shaft 60 to apply a clamping force to the power output shaft 60 from two opposite directions, the C-shaped elastic member 50 is sleeved on the outside of the connection body 45 to apply a pressing force to the two elastic protrusions 42, 43 so as to reliably connect the connection member 40 with the power output shaft 60, and then the connection member 40 cooperates with the corresponding connecting groove inside the bar of the toothbrush head through the rib 41 at the external wall of the connection body 45 to achieve a reliable connection between the connection member 40 and the toothbrush head.

Although the aforementioned shaft coupler of the electric toothbrush has the advantage of a reliable connection between the toothbrush head and the toothbrush handle of the electric toothbrush, the following technical problem would occur when the conventional electric toothbrush is in batch production. Because machining deviation, which cannot be avoided in the manufacturing process, would result in the misalignment of the toothbrush head and the power output shaft, power consumption would increase in the process of power transmission and the toothbrush head would move unstably.

### SUMMARY

The objective of the present disclosure is to provide a shaft coupler configured to connect to an electric toothbrush head and a power output shaft, and by virtue of the shaft coupler of the present disclosure, the coaxiality of the toothbrush head and the power output shaft can become better after the toothbrush head and the power output shaft are connected, and the connection between the toothbrush head and the power output shaft can become more reliable, so that the toothbrush head can move more stably and less power is consumed.

According to one exemplary embodiment of the present disclosure, a shaft coupler configured to connect to an electric toothbrush head and a power output shaft is provided, including a connection member (1) configured to receive the power output shaft and an elastic member (2) configured to apply a pressing force to the connection member (1); in which a connection body (14) of the connection member (1) is disposed with two openings (143, 144) extending along an axial direction, the two openings (143, 144) are configured to divide at least one section of the connection body (14) into two opposite clamping portions (141, 142) along the axial direction and the elastic member (2) is sleeved at an outer periphery of the two clamping portions (141, 142) for applying an elastic force which is capable of making the two clamping portions (141, 142) vibrate the power output shaft in the two clamping portions (141, 142).

In a preferred embodiment, the elastic member (2) is an enclosed metal cover, and the metal cover includes a contact portion (21) being in physical contact with one portion of an external wall of the connection body (14) and an arc-shaped portion (22) opposite to the other portion of the external wall of the connection body (14) and having a certain distance therebetween.

In a preferred embodiment, the elastic member (2) includes two contact portions (21) and two arc-shaped portions (22), and the two contact portions (21) are opposite to each other and the two arc-shaped portions (22) are opposite to the two openings (143, 144) of the connection body (14).

In a preferred embodiment, a second connection portion (13) is disposed at the rear end of the connection body (14), and the second connection portion (13) includes a main body portion in which an axial bore (132) is disposed and a touch pressing strip (131) extending along the radial direction of the axial bore (132) and connecting to the main body portion through two end portions of the touch pressing strip (131); when the power output shaft penetrates the axial bore (132), an external wall of the power output shaft is in physical contact with the touch pressing strip (131) and enables the touch pressing strip (131) to deform.

In a preferred embodiment, a protrusion (133) is disposed on an internal side of the touch pressing strip (131) and configured to position the front and the rear directions of the power output shaft.

In a preferred embodiment, a third connection portion (12) is disposed at the rear end of the second connection portion (13) and includes a first outer protruding ring extending outwardly along a peripheral edge at the rear end of the second connection portion (13), in which a front protruding ring (121) is disposed at an outer edge of the first outer protruding ring and includes an ultrasonic bonding line, and the front protruding ring (121) is connected with a corresponding portion (33) inside a toothbrush head (3) through ultrasonic bonding.

In a preferred embodiment, a fourth connection portion (11) is disposed at the rear end of the third connection portion (12), and is frustum-shaped.

In a preferred embodiment, diameters of the connection body (14), the second connection portion (13), the third connection portion (12) and the fourth connection portion (11) are sequentially increased.

In a preferred embodiment, a diameter at the front end of the connection body (14) is smaller than a diameter at the rear end of the connection body (14), a second outer protruding ring (15) is disposed at an outer edge at the front end of the connection body (14), a front end surface (151) of the second outer protruding ring (15) is a tapered slope, and an axial positioning portion (152) of the elastic member (2) is formed at the rear end of the second outer protruding ring (15).

In addition, the present disclosure further provides an electric toothbrush head, including a bar of the toothbrush head and a shaft coupler disposed on the bar of the toothbrush head and configured to removably assemble the toothbrush head on a power output shaft extending from the front end of the toothbrush handle and carry out torque transmission and axial retention of the toothbrush head relative to the power output shaft, in which the shaft coupler is according to any one of the aforementioned shaft couplers.

Compared with the existing technology, the present disclosure has the following advantages. Because the connection body is disposed with two openings extending along an axial direction to divide at least one section of the connection body into two opposite clamping portions along the axial direction and under the function of the elastic member the two clamping portions are both fastened to the power output shaft, that is, the connection body being fastened from two opposite directions, the technical problem of the unavoidable misalignment resulting from machining deviation in the manufacturing process between the toothbrush head and the power output shaft that cannot be resolved through a unidirectional fastening can be overcome. Consequently, the coaxiality of the toothbrush head and the power output shaft can become better after the toothbrush head and the power output shaft are connected, and the connection between the toothbrush head and the power output shaft can become more reliable, so that the toothbrush head can move more stably and less power is consumed.

### BRIEF DESCRIPTION OF THE DRAWINGS

FIGS. 1a and 1b are schematic diagrams respectively illustrating the structures of a connection member and an elastic member of a shaft coupler of an existing electric toothbrush, and FIG. 1c is a schematic diagram illustrating a power output shaft of an existing electric toothbrush.

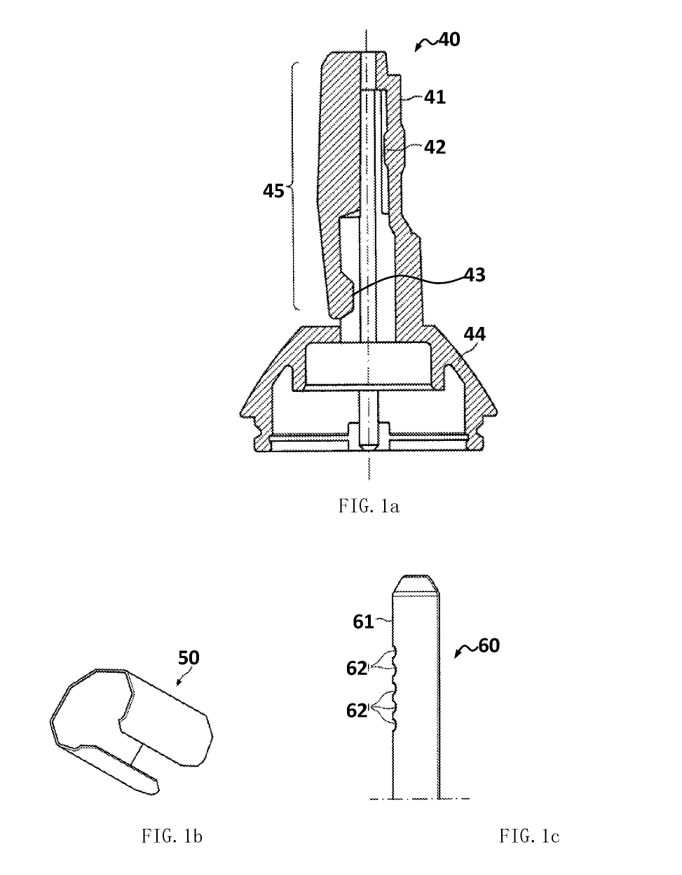

FIG. 2 is an exploded diagram of the shaft coupler according to an exemplary embodiment of the present disclosure.

FIGS. 3a, 3b, 3c and 3d are respectively a side view, a front view, a cross-sectional view along C-C of FIG. 3b, and a cross-sectional view along B-B of FIG. 3b according to an exemplary embodiment of the present disclosure.

FIGS. 4a and 4b are respectively a side view and a top view of the elastic member according to an exemplary embodiment of the present disclosure.

FIGS. 5a and 5b are respectively a side view of the toothbrush head and a cross-sectional view along A-A of FIG. 5a according to an exemplary embodiment of the present disclosure.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

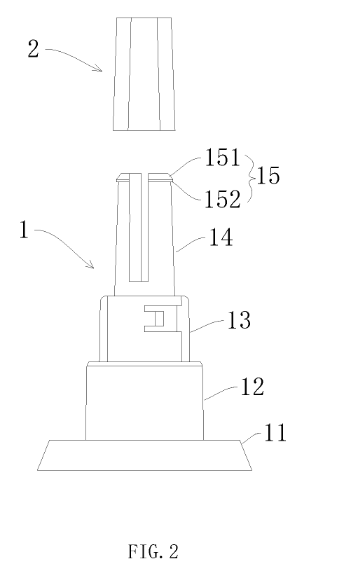

Referring to FIG. 2, a shaft coupler configured to receive a connection member 1 extending from a front end of a toothbrush handle of an electric toothbrush and an elastic member 2 according to an exemplary embodiment of the present disclosure are shown.

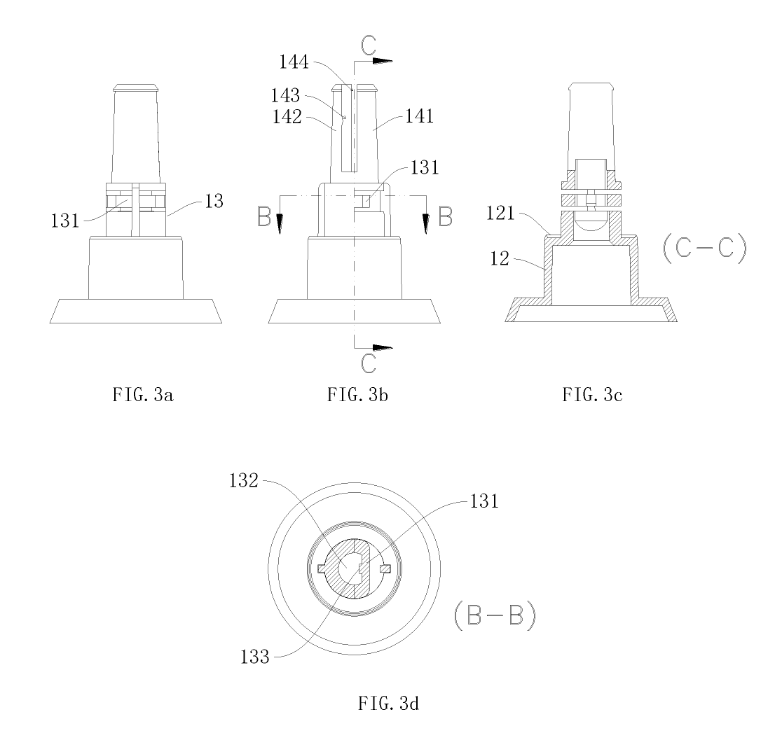

Reference is made to FIG. 2 along with FIGS. 3a, 3b, 3c and 3d. A connection body 14 of the connection member 1 is disposed with two openings 143, 144 extending along an axial direction, and the two openings 143, 144 are configured to divide at least one section of the connection body 14 into two opposite clamping portions 141, 142 along the axial direction.

The elastic member 2 is sleeved at an outer periphery of the two clamping portions 141, 142 for applying an elastic force which is capable of making the two clamping portions 141, 142 vibrate the power output shaft in the two clamping portions 141, 142.

Because the connection body 14 is disposed with two openings 143, 144 extending along an axial direction to divide at least one section of the connection body 14 into two opposite clamping portions 141, 142 along the axial direction and under the function of the elastic member 2 the two clamping portions 141, 142 are both fastened to the power output shaft, that is, the connection body 14 being fastened from two opposite directions, the technical problem of the unavoidable misalignment resulting from machining deviation in the manufacturing process between the toothbrush head and the power output shaft that cannot be resolved through a unidirectional fastening can be overcome. Consequently, the coaxiality of the toothbrush head and the power output shaft can be better after the toothbrush head and the power output shaft are connected, and the connection between the toothbrush head and the power output shaft can be more reliable, so that the toothbrush head can move more stably and less power is consumed.

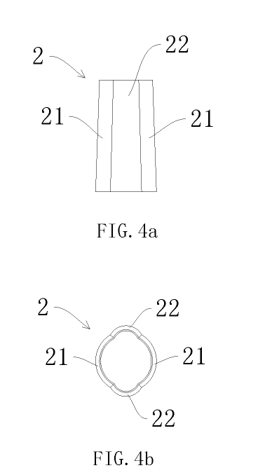

Reference is made to FIG. 2 along with FIGS. 4a and 4b. The elastic member 2 is an enclosed metal cover, and the metal cover includes a contact portion 21 being in physical contact with one portion of an external wall of the connection body 14 and an arc-shaped portion 22 opposite to the other portion of the external wall of the connection body 14 and having a certain distance therebetween. By assembling the fully enclosed metal elastic ring (metal cover) at each outer edge of the two clamping portions 141, 142 of the connection body 14, the elastic reinforcement and fastening function can effectively overcome the technical problem of the unstable elastic force and elastic fatigue due to the purely plastic positioning structure and semi-enclosed metal elastic ring which are commonly applied to the shaft coupler of the existing electric toothbrush.

Further, the elastic member 2 includes two contact portions 21 and two arc-shaped portions 22, and the two contact portions 21 are opposite to each other and the two arc-shaped portions 22 are opposite to the two openings 143, 144 of the connection body 14 (as shown in FIG. 3b). By virtue of the structure, the two clamping portions 141, 142 can be applied with force more uniformly. Here, the present disclosure is not limited to the aforementioned structure, and can include four, six, or only one arc-shaped portion.

Reference is made to FIG. 2 along with FIGS. 3a, 3b, 3c and 3d. A second connection portion 13 is disposed at the rear end of the connection body 14, and the second connection portion 13 includes a main body portion in which an axial bore 132 is disposed and a touch pressing strip 131 extending along the radial direction of the axial bore 132 and connecting to the main body portion through two end portions of the touch pressing strip 131; when the power output shaft penetrates the axial bore 132, an external wall of the power output shaft is in physical contact with the touch pressing strip 131 and enables the touch pressing strip 131 to deform. In other words, the touch pressing strip 131 can provide a radial pressure to the power output shaft to further overcome the technical problem of the unavoidable misalignment resulting from machining deviation in the manufacturing process between the toothbrush head and the power output shaft. In a preferred embodiment, the direction where the touch pressing strip 131 applies pressure to the power output shaft is vertical to the direction where the two clamping portions 141, 142 apply pressure to the power output shaft.

Moreover, a protrusion 133 is disposed on an internal side of the touch pressing strip 131 (one side adjacent to the power output shaft) and configured to position the front and the rear directions of the power output shaft.

Compared with only one end portion of a touch pressing strip being connected to the main body portion, the touch pressing strip 131 of the present disclosure is connected to the main body portion through two end portions thereof, that is, an enclosed elastic structure is provided. The enclosed elastic structure can achieve better fastening and stable elasticity without producing elastic fatigue easily, so that the service life can be prolonged.

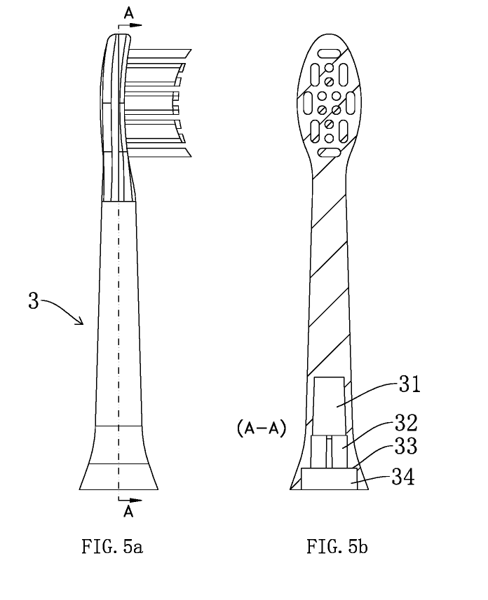

Reference is made to FIG. 2 along with FIGS. 3c and 5b. A third connection portion 12 is disposed at the rear end of the second connection portion 13 and includes a first outer protruding ring extending outwardly along a peripheral edge at the rear end of the second connection portion 13, in which a front protruding ring 121 is disposed at an outer edge of the first outer protruding ring and includes an ultrasonic bonding line, and the front protruding ring 121 is connected with a corresponding portion 33 inside a toothbrush head 3 through ultrasonic bonding. By using the ultrasonic bonding technology, the shaft coupler can be integrally bonded with the toothbrush head, thereby overcoming the probability of loosening resulting from interference to the fit or clamping installation which is adapted commonly by the shaft coupler of conventional electric toothbrushes.

Referring to FIG. 2, a fourth connection portion 11 is disposed at the rear end of the third connection portion 12, and is frustum-shaped. The fourth connection portion 11 forms a transition structure between the rear end of the bar of the toothbrush head and the front end of the toothbrush handle to maintain a smooth transition in the connection portion.

In addition, as shown in FIG. 2, diameters of the connection body 14, the second connection portion 13, the third connection portion 12 and the fourth connection portion 11 are sequentially increased. Referring to FIGS. 5a and 5b, a first containing cavity 31, a second containing cavity 32 and a third containing cavity 34 are correspondingly disposed at the bar of the toothbrush head, and are respectively used to contain the connection body 14, the second connection portion 13 and the third connection portion 12.

Furthermore, a diameter at the front end of the connection body 14 is smaller than a diameter at the rear end of the connection body 14, a second outer protruding ring 15 is disposed at an outer edge at the front end of the connection body 14, a front end surface 151 of the second outer protruding ring 15 is a tapered slope, and an axial positioning portion 152 of the elastic member 2 is formed at the rear end of the second outer protruding ring 15. The front end surface 151 combines the two openings 143, 144 to enable the enclosed elastic member 2 to be sleeved at the outer edge of the connection body 14 successfully, and the axial positioning portion 152 is configured to prevent the elastic member 2 from slipping from the front end of the connection body 14.

In practice, the shaft coupler is inserted into the rear end of the bar of the toothbrush head 3, the connection member 14, the second connection portion 13 and the third connection portion 12 of the shaft coupler are correspondingly connected to the first containing cavity 31, the second containing cavity 32 and the third containing cavity 34, and the front protruding ring 121 of the third connection portion 12 is bonded with the front wall of the third containing cavity 34 through ultrasonic bonding, so that the connection between the toothbrush head and the toothbrush handle can be achieved through the combination of the shaft coupler and the power output shaft extending from the front end of the toothbrush handle.

The above-mentioned descriptions represent merely an exemplary embodiment of the present disclosure, without any intention to limit the scope of the present disclosure thereto. Various equivalent changes, alterations or modifications based on the claims of the present disclosure are all consequently viewed as being embraced by the scope of the present disclosure.

What is claimed is:

1. A shaft coupler configured to connect an electric toothbrush head and a power output shaft, comprising:
a connection member (1) configured to receive the power output shaft and an elastic member (2) configured to apply a pressing force to the connection member (1); wherein a connection body (14) of the connection member (1) is disposed with two openings (143, 144) extending along an axial direction, the two openings (143, 144) are configured to divide at least one section of the connection body (14) into two opposite clamping portions (141, 142) along the axial direction and the elastic member (2) is sleeved at an outer periphery of the two clamping portions (141, 142) for applying an elastic force which is capable of making the two clamping portions (141, 142) vibrate the power output shaft in the two clamping portions (141, 142).

2. The shaft coupler according to claim 1, wherein the elastic member (2) is an enclosed metal cover, and the metal cover comprises a contact portion (21) being in physical contact with one portion of an external wall of the connection body (14) and an arc-shaped portion (22) opposite to the other portion of the external wall of the connection body (14) and having a certain distance therebetween.

3. The shaft coupler according to claim 2, wherein the elastic member (2) comprises two contact portions (21) and two arc-shaped portions (22), and the two contact portions (21) are opposite to each other and the two arc-shaped portions (22) are opposite to the two openings (143, 144) of the connection body (14).

4. The shaft coupler according to claim 1, wherein a second connection portion (13) is disposed at the rear end of the connection body (14), and the second connection portion (13) comprises a main body portion in which an axial bore (132) is disposed and a touch pressing strip (131) extending along the radial direction of the axial bore (132) and connecting to the main body portion through two end portions of the touch pressing strip (131); when the power output shaft penetrates the axial bore (132), an external wall of the power output shaft is in physical contact with the touch pressing strip (131) and enables the touch pressing strip (131) to deform.

5. The shaft coupler according to claim 4, wherein a protrusion (133) is disposed at an internal side of the touch pressing strip (131) and configured to position the front and the rear directions of the power output shaft.

6. The shaft coupler according to claim 4, wherein a third connection portion (12) is disposed at the rear end of the second connection portion (13) and comprises a first outer protruding ring extending outwardly along a peripheral edge at the rear end of the second connection portion (13), wherein a front protruding ring (121) is disposed at an outer edge of the first outer protruding ring and comprises an ultrasonic bonding line, and the front protruding ring (121) is connected with a corresponding portion (33) inside a toothbrush head (3) through ultrasonic bonding.

7. The shaft coupler according to claim 6, wherein a fourth connection portion (11) is disposed at the rear end of the third connection portion (12), and is frustum-shaped.

8. The shaft coupler according to claim 7, wherein diameters of the connection body (14), the second connection portion (13), the third connection portion (12) and the fourth connection portion (11) are sequentially increased.

9. The shaft coupler according to claim 1, wherein a diameter at the front end of the connection body (14) is smaller than a diameter at the rear end of the connection body (14), a second outer protruding ring (15) is disposed at an outer edge at the front end of the connection body (14), a front end surface (151) of the second outer protruding ring (15) is a tapered slope, and an axial positioning portion (152) of the elastic member (2) is formed at the rear end of the second outer protruding ring (15).

10. An electric toothbrush head, comprising a bar of the toothbrush head and a shaft coupler according to claim 1, wherein the shaft coupler is disposed on the bar of the toothbrush head and configured to removably assemble the toothbrush head on a power output shaft extending from the front end of the toothbrush handle and carry out torque transmission and axial retention of the toothbrush head relative to the power output shaft.

11. An electric toothbrush head, comprising a bar of the toothbrush head and a shaft coupler according to claim 2, wherein the shaft coupler is disposed on the bar of the toothbrush head and configured to removably assemble the toothbrush head on a power output shaft extending from the front end of the toothbrush handle and carry out torque transmission and axial retention of the toothbrush head relative to the power output shaft.

12. An electric toothbrush head, comprising a bar of the toothbrush head and a shaft coupler according to claim 3, wherein the shaft coupler is disposed on the bar of the toothbrush head and configured to removably assemble the toothbrush head on a power output shaft extending from the front end of the toothbrush handle and carry out torque transmission and axial retention of the toothbrush head relative to the power output shaft.

13. An electric toothbrush head, comprising a bar of the toothbrush head and a shaft coupler according to claim 4, wherein the shaft coupler is disposed on the bar of the toothbrush head and configured to removably assemble the toothbrush head on a power output shaft extending from the front end of the toothbrush handle and carry out torque transmission and axial retention of the toothbrush head relative to the power output shaft.

14. An electric toothbrush head, comprising a bar of the toothbrush head and a shaft coupler according to claim 5, wherein the shaft coupler is disposed on the bar of the toothbrush head and configured to removably assemble the toothbrush head on a power output shaft extending from the front end of the toothbrush handle and carry out torque transmission and axial retention of the toothbrush head relative to the power output shaft.

15. An electric toothbrush head, comprising a bar of the toothbrush head and a shaft coupler according to claim 6, wherein the shaft coupler is disposed on the bar of the toothbrush head and configured to removably assemble the toothbrush head on a power output shaft extending from the front end of the toothbrush handle and carry out torque transmission and axial retention of the toothbrush head relative to the power output shaft.

16. An electric toothbrush head, comprising a bar of the toothbrush head and a shaft coupler according to claim 7, wherein the shaft coupler is disposed on the bar of the toothbrush head and configured to removably assemble the toothbrush head on a power output shaft extending from the front end of the toothbrush handle and carry out torque transmission and axial retention of the toothbrush head relative to the power output shaft.

17. An electric toothbrush head, comprising a bar of the toothbrush head and a shaft coupler according to claim 8, wherein the shaft coupler is disposed on the bar of the toothbrush head and configured to removably assemble the toothbrush head on a power output shaft extending from the front end of the toothbrush handle and carry out torque transmission and axial retention of the toothbrush head relative to the power output shaft.

18. An electric toothbrush head, comprising a bar of the toothbrush head and a shaft coupler according to claim 9, wherein the shaft coupler is disposed on the bar of the toothbrush head and configured to removably assemble the toothbrush head on a power output shaft extending from the front end of the toothbrush handle and carry out torque transmission and axial retention of the toothbrush head relative to the power output shaft.
